(19) United States
(12) Patent Application Publication
(10) Pub. No.: US 2023/0053884 A1
(43) Pub. Date: Feb. 23, 2023

(54) SYSTEMS AND METHODS FOR DISTRICT HEATING AND COOLING

(71) Applicant: PHASE CHANGE ENERGY SOLUTIONS, INC., Greensboro, NC (US)

(72) Inventors: Jeremy Mabe, Greensboro, NC (US); Scott A. Queen, Greensboro, NC (US); Rami M. Saeed, Greensboro, NC (US)

(73) Assignee: PHASE CHANGE ENERGY SOLUTIONS, INC., Greensboro, NC (US)

(21) Appl. No.: 17/791,989

(22) PCT Filed: Jan. 8, 2021
(86) PCT No.: PCT/US2021/012752

§ 371 Date: Jul. 11, 2022

Related U.S. Application Data
(60) Provisional application No. 62/959,549, filed on Jan. 10, 2020.

(51) Int. Cl. F24F 5/00; F16L 9/19

(52) U.S. Cl. CPC F24F 5/0021; F16L 9/19

(57) ABSTRACT

District energy systems, also known as district heating and cooling networks, are utilized to provide distributed heating and cooling through an infrastructure of pipes and connectors from source points to destination addresses. The application of PCM within the network of pipes and connectors and with the surrounding environment improves the thermal regulation goals of transferring thermal energy in fluid form from source to destination, often times over great distances and through varying environmental conditions.

### CROSS-REFERENCE TO RELATED APPLICATIONS

The present patent application claims the benefit and priority of U.S. Provisional Patent Application No. 62/959,549 filed on Jan. 10, 2020, titled “SYSTEMS AND METHODS FOR DISTRICT HEATING AND COOLING,” the contents of which is hereby incorporated by reference in its entirety.

### FIELD

The present disclosure relates to district energy systems, namely heating and cooling systems. The disclosure further delineates utilizing phase change materials (PCM), and methods of absorbing, releasing, controlling, and regulating thermal energy within district energy systems.

### BACKGROUND

District energy systems, also known as district heating and/or cooling systems (DHC), are thermal grids that distribute heating and cooling by transporting hot and cold water, or other fluid, to various destination points through a network of pipes and connectors. District energy systems take advantage of various technologies to provide energy efficient temperature applications in a centralized location. Heat generated from industrial processes or boilers, often times waste heat, is utilized in a complex network of pipes and connectors to transfer the thermal energy to various use cases and or destinations. Similarly, in a cooling network, distribution of cooling energy from a cooling source, such as a body of water or chilled water source, is routed through a system of pipes and connectors to transfer the thermal energy to various use cases.

A heat network within a district energy system has four main components. The first is a heat generating unit, which can be any industrial or otherwise process such as solar generated heating units or industrial waste heat from a nuclear facility. The second component is a primary pipeline or pipeline network that transfers the heat to delivery points. Delivery points can be residential heat usage, industrial usage, commercial buildings, or any such point where the application of heat is desired. The third component is a heat exchanger substation, which connects the main pipeline to the delivery point. The fourth component is distribution from the heat exchanger substation to points within the desired location, such as radiant sources of heat in a home.

A district energy cooling network operates in similar fashion to a heat network. In a cooling network we start at the cooling source, which can be a natural cooling source such as a lake, ocean, or body of water, or through mechanical means such as a chiller, any source that is capable of producing chilled water or fluid can serve as a cooling source. Next, a cooling network or primary pipeline to destination or delivery points distributes the chilled water or fluid throughout the district energy system. Next, a customer interface or energy transfer station takes the distributed chilled water from the network of pipes and/or connectors and further distribute it to a destination address through smaller pipes and connectors directly to users.

District cooling systems are divided into three groups based on supply temperatures. The first is conventional cooling, from chilled source water, typically around 4° C. to 7° C. The second is ice water systems, usually around 1° C. Lastly, ice slurry systems around −1° C. Further, district cooling networks can be customized for the expected usage. For example, a cooling network for conditioned air services operates as a closed circuit, wherein a chilled water supply is delivered to an air conditioning system, and the utilized water supply is returned back to the chilled water supply source. The closed circuit typically has two pipelines, one supplying the chilled water, and the other returning it to the chilling source. In other systems the cooling source is at multiple junctures in the circuit and provide sustainable water temperatures along the networked route.

Temperature control within the pipes and connectors is often achieved by insulation. Due to the scale of district energy networks the cost of more advanced insulation materials is often not feasible. Further exacerbating the problem, is the loss of thermal energy over greater distances, location ground temperatures, and pipe and connector sizing, to name a few. The result often requires additional stages of heating or cooling and additional applications such as potentially higher/lower degrees of thermal energy. Ultimately increasing the risk on equipment within the system as well as operational costs and maintenance.

District energy systems pipe and connector insulation applications aid the network in efficiency. However, there remains a need to further support desired temperatures that does not involve expensive materials and/or costly maintenance.

### SUMMARY

District energy systems and district heating and or cooling systems as referred to herein are interchangeable, a district energy system may contain one part (heating or cooling) or both parts (heating and cooling), or a combination thereof for the various needs, including intermediary stages where a mixture of heating and cooling is used, such as exchange subsystems. In one aspect, heating pipes flowing from a district energy heating system are integrated with interior pipes containing PCM. The interior pipes are designed to operate in an unobtrusive fashion (not hindering fluid flow), equipped to handle the thermal conditions within the exterior pipe, and to provide non mechanical temperature control. In other aspects the exterior pipe of a district energy system is insulated and the interior pipes (filled with PCM) orbit radially in the interior of the insulated exterior pipe. The structure of the interior pipes does not follow any required pattern, and is dependent upon a multitude of factors including the size of the exterior pipe, the size of the interior pipe(s), the PCM involved, the flow rate, the location of the pipes to the source point, the location of the pipes to the destination point, and the contents of the flowing fluid, to name a few. In additional aspects, the interior pipes are exchangeable through a gasket housing to allow interchange as the district energy system grows, shrinks, adapts, or repurposes. The ratio of interior pipes often depends upon the dimension of the outer pipe, flow rate of the internal fluid, PCM involved, location to source and destination, all in coordination with the thermal energy goals of the system, and aspects of the surrounding environment.

In additional embodiments the interior pipes are reduced in circumference and increased in numerosity to account for greater levels of surface area contact to the fluid within the exterior pipe. In other embodiments there may be only a single interior pipe filled with PCM that is near the source point for control at the destination. In further embodiments, the large exterior pipe may have a slightly smaller interior pipe, wherein the PCM is housed between the exterior pipe and the interior pipe and the district energy fluid or water is transported inside the interior pipe. Thus forming a PCM insulated surface around the circumference of the interior pipe. Such pipes may be made or extruded prior to installation or retrofitted onto existing apparatus as a pipe in pipe design. In even further embodiments the interior pipes are moved to exterior pipes surrounding a large pipe that transports the district energy fluid. In this embodiment the PCM filled exterior pipes assist and regulate the surrounding environment and can be attached to transfer thermal energy from the contact surface of the fluid flowing pipe.

Any size pipe or connector that is suitable for contact with a district energy source fluid is applicable to the disclosure, examples such as water, grey water, and black water are contemplated, but form a non-exhaustive list of applicable fluids that can be transported through a district energy system to provide heating and cooling needs. In one aspect the interior pipe is equipped to contain and hold the PCM material from contact with the fluid inside the DES. In other aspects the PCM material may flow through a grid system of interior pipes in a continual cycle back to a source point that may heat or cool.

In the example embodiments the composition of the interior pipes is often a metal with a high degree of thermal conductivity, examples include aluminum, copper, brass, steel, and bronze. However, in additional embodiments metal pipes with lower thermal conductivity (iron) may be used if they possess aspects such as cost savings, applicability to the current system, corrosion resistance, or other properties that will be known to those of skill in the art. In further embodiments the interior pipes may comprise high density polyethylene (HDPE), or polyvinyl chloride (PVC), both of which have a low thermal conductivity but nonetheless are cost efficient, durable, and scalable. When fitting metal pipes within the district energy system it may be important for dielectric coupling or an isolating gasket that is pressure rated to prevent fixed joining or unintended metal fusing.

In some embodiments, a “pipe in pipe” design is used. In such embodiments, the approach of the pipe-in-pipe design is to utilize a large district heating and cooling system's existing water transport pipes and install smaller diameter pipes filled with PCM internal to the large district heating and cooling pipes. Not intending to be bound by theory, installing PCM into smaller 2.5-3″ diameter pipes and then installing those pipes into the larger (usually a 24″ or larger diameter) water or fluid pipes, the PCM will act as an integral thermal storage device internal to the piping system thus eliminating the need for extra thermal storage tanks. The smaller diameter piping filled with PCM can be manufactured in shorter lengths compared to that of the length of the large diameter water transport piping and then installed around the perimeter and internal to the water transport piping. In some embodiments, the PCM filled piping runs the full length of the water distribution piping. In certain other embodiments, it is not necessary for the PCM filled piping to run the full length of the water distribution piping unless it is desired for extra thermal storage capacity. In certain instances, the PCM filled piping is fully enclosed to prevent contamination of the water being transported through the large diameter piping with PCM (that is, the PCM is sequestered or enclosed within the interior pipes or tubes, such that PCM is not exposed to the water flowing through the large district heating and cooling piping). The amount of PCM piping and the set point of the PCM can be based upon the total thermal storage capacity and leaving water temperature desired for the system. It is noted that the PCM filled piping may be thin sheets of material that house the PCM, in this regard the pipes are more representative as fins or blades that are filled with PCMs. The use of traditional pipes is to lower the effective cost and allow reconfiguration and engineering with existing infrastructure, however, additional embodiments allow for pipe design that may increase the surface area and thermal connectivity of the PCM with the fluid and the environment.

In some embodiments, when chilled water is available below the temperature of the freeze point of the PCM, the water will flow through the large diameter transport pipes around the PCM filled pipes. The PCMs will release stored latent heat into the water and will charge/freeze internal to the smaller piping. In certain embodiments, this would occur during the nighttime hours when the ambient temperatures are lower. In such embodiments, water being pumped from a natural reservoir can be increased in temperature to a desired level. However, in certain other embodiments, mechanical means of managing the temperature of the water may be used in combination with the PCM. In such instances, the PCM may operate to increase the energy efficiency of the mechanical cooling or heating element. When warmer water is transported through the large diameter piping the PCM will then absorb the latent heat from the warmer water, melt/discharge and cool down the water that is being transported to the desired leaving water temperature. In certain embodiments, this occurs during the day when ambient temperatures are higher and natural reservoir water temperatures are also higher. By utilizing the latent heat stored in the PCM, it is possible to cool down that water without a need for mechanical cooling to the desired leaving water temperature from the larger transport pipe. CFD modelling can be used to determine the estimated number of smaller PCM pipes and what temperature is needed for the PCM set point.

When used in conjunction with district heating systems, the reverse of the process described above happens. When warmer water is being transported/pumped from a reservoir, the PCM in the smaller pipes absorbs/stores the latent heat from the warmer water and melts as a result. When cooler water is all that is available at other times, the water will again pass over the melted PCM, or in a first phase or second phase, isolate or gel, or any other phase (including mesophase), in the internal piping and the PCM will release the stored latent heat back into the water, thus warming it up to the desired water temperature.

Any PCM not inconsistent with the objectives of the present disclosure can be used within the pipes and connectors. In some cases, for instance, a PCM comprises one or more of the following a salt hydrate; a fatty acid (e.g., having a C4 to C28 aliphatic hydrocarbon tail, which can be saturated or unsaturated, linear or branched, where a chemical species described as a “Cn” species (e.g., a “C4” species or a “C28” species) is a species of the identified type that includes exactly “n” carbon atoms; thus, a C4 to C28 aliphatic hydrocarbon tail refers to a hydrocarbon tail that includes between 4 and 28 carbon atoms); an alkyl ester of a fatty acid (such as a C2 to C6 ester alkyl backbone or a C6 to C12 ester alkyl backbone or a C12 to C28 ester alkyl backbone); a fatty alcohol (such as a fatty alcohol having a C4 to C28 aliphatic hydrocarbon tail); a fatty carbonate ester, sulfonate, or phosphonate (such as a C4 to C28 alkyl carbonate ester, sulfonate, or phosphonate); a paraffin; a polymeric material (such as a polymeric material). In some cases, the PCM is a PCM solder under the trade name BioPCM®, available from Phase Change Energy Solutions (Asheboro, N.C.), such as BioPCM-(−8), BioPCM-(−6), BioPCM-(−4), BioPCM-(−2), BioPCM-4, BioPCM-6, BioPCM 08, BioPCM-Q12, BioPCM-Q15, BioPCM-Q18, BioPCM-Q20, BioPCM-Q21, BioPCM-Q23, BioPCM-Q25, BioPCM-Q27, BioPCM-Q30, BioPCM-Q32, BioPCM-Q35, BioPCM-Q37, BioPCM-Q42, BioPCM-Q49, BioPCM-55, BioPCM-60, BioPCM-62, BioPCM-65, BioPCM-69, and others.

Further, PCM described herein can comprise a plurality of differing PCMs, including differing PCMs of differing types. Any mixture or combination of differing PCMs not inconsistent with the objectives of the present disclosure may be used. In some embodiments, for example, the PCM inside the pipe or connector comprises one or more fatty acids and one or more fatty alcohols. Further, as described above, a plurality of differing PCMs, in some cases, is selected based on a desired phase transition temperature and/or latent heat of the mixture of PCMs. It will be known that PCM's relative to the cold side of district cooling carry set parameters and mixtures that benefit the particular location. For example, a PCM with a lower temperature transition phase may be near the cold source, whereas a PCM with a higher temperature transition phase may be placed near the destination. Due to the scale and complexity of district energy systems, a variety of PCMs may be utilized to focus on region specific goals across district energy systems.

Further, in some embodiments, one or more properties of a PCM described herein can be modified by the inclusion of one or more additives. Such an additive described herein can be mixed with a PCM and/or disposed in a pipe or connector described herein. In some embodiments, an additive comprises a thermal conductivity modulator. A thermal conductivity modulator, in some embodiments, increases the thermal conductivity of the PCM. In some embodiments, a thermal conductivity modulator comprises carbon, including graphitic carbon. In some embodiments, a thermal conductivity modulator comprises carbon black and/or carbon nanoparticles. Carbon nanoparticles, in some embodiments, comprise carbon nanotubes and/or fullerenes. In some embodiments, a thermal conductivity modulator comprises a graphitic matrix structure. In other embodiments, a thermal conductivity modulator comprises an ionic liquid. In some embodiments, a thermal conductivity modulator comprises a metal, including a pure metal or a combination, mixture, or alloy of metals. Any metal not inconsistent with the objectives of the present disclosure may be used. In some embodiments, a metal comprises a transition metal, such as silver or copper. In some embodiments, a metal comprises an element from Group 13 or Group 14 of the periodic table. In some embodiments, a metal comprises aluminum, or aluminum alloys such as 1050A, 6060, 6063. Additionally, composite materials may be used such as copper-tungsten pseudo alloy, silicon carbide in an aluminum matrix, diamond in copper silver alloy matrix, and e-material such as beryllium oxide in beryllium matrix. In some embodiments, a thermal conductivity modulator comprises a metallic filler dispersed within a matrix formed by the PCM. In some embodiments, a thermal conductivity modulator comprises a metal matrix structure or cage-like structure, a metal tube, a metal plate, and/or metal shavings. Further, in some embodiments, a thermal conductivity modulator comprises a metal oxide. Any metal oxide not inconsistent with the objectives of the present disclosure may be used. In some embodiments, a metal oxide comprises a transition metal oxide. In some embodiments, a metal oxide comprises alumina.

In other embodiments, an additive comprises a nucleating agent. A nucleating agent has a surface charge that is opposite to the partial charge of the chemical moiety of the polymer. Nucleating agents accelerate the rate of crystallization, and a melting point that is greater than the melting point of the melt processible polymer. A nucleating agent, in some embodiments, can help avoid subcooling, particularly for PCMs comprising finely distributed phases, such as fatty alcohols, paraffinic alcohols, amines, and paraffins. Any nucleating agent not inconsistent with the objectives of the present disclosure may be used.

Moreover, in some embodiments, a PCM comprises a paraffin. Any paraffin not inconsistent with the objectives of the present disclosure may be used. In some embodiments, a PCM comprises n-dodecane, n-tridecane, n-tetradecane, n-pentadecane, n-hexadecane, n-heptadecane, n-octadecane, n-nonadecane, n-eicosane, n-heneicosane, n-docosane, n-tricosane, n-tetraco sane, n-pentaco sane, n-hexaco sane, n-heptaco sane, n-octaco sane, n-nonaco sane, n-triacontane, n-hentriacontane, n-dotriacontane, n-tritriacontane, and/or mixtures thereof.

In addition, in some embodiments, a PCM comprises a polymeric material. Any polymeric material not inconsistent with the objectives of the present disclosure may be used. Non-limiting examples of suitable polymeric materials for use in some embodiments described herein include thermoplastic polymers (e.g., poly(vinyl ethyl ether), poly(vinyl n-butyl ether) and polychloroprene), polyethylene glycols (e.g., CARBOWAX® polyethylene glycol 400, CARBOWAX® polyethylene glycol 600, CARBOWAX® polyethylene glycol 1000, CARBOWAX® polyethylene glycol 1500, CARBOWAX® polyethylene glycol 4600, CARBOWAX® polyethylene glycol 8000, and CARBOWAX® polyethylene glycol 14,000), and polyolefins (e.g., lightly crosslinked polyethylene and/or high density polyethylene).

Additionally, in some embodiments, the PCM component changes phase from a first phase to a second phase by exposing the phase change material to an ambient temperature below a phase change (or transition) temperature of the phase change material. Further, in a method or system described herein includes the ability of reverting the phase change material to the first phase due to the thermal energy produced by the water or material within the outer pipe or main transport pipe of the district energy system (or other heat-generating source). During this process, the temperature or thermal energy of the heat source can be maintained at or above the PCM temperature.

As described further herein, the PCM material, in some preferred embodiments, has a “freezing” point or temperature (or other “low end” phase transition point or temperature) that is high enough to passively charge under normal ambient conditions (for example, around 1° C.), and a “melting” point or temperature (or other “high end” phase transition point or temperature) that is low enough to control heating within the district energy cooling system by absorbing heat (for example, around 7° C.). Similar applications are available in the heating side of district energy systems.

It should further be noted that the various components of systems and units described herein (for example, the PCM-containing components such as the pipes and connectors) can have any physical dimensions not inconsistent with the objectives of the present disclosure. For example, in some cases, the PCM containing pipe or connector is housed in multiple layers, for example—housed within a main pipe, exterior pipe, interior pipe (as a sublayer/sub-pipe), a connector, or line to produce the effective goals of thermal regulation and thermal control in district energy systems.

These and other implementations are described in more detail in the drawings and detailed description which follows.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure.

FIG. 1 sets forth an illustration of an example embodiment of a district energy system exterior pipe and a series of interior pipes filled with phase change materials.

FIG. 2 sets forth an example illustration of a district energy system.

FIG. 3 sets forth an illustration of an example embodiment of a district energy system exterior pipe and a series of interior pipes filled with phase change materials.

FIG. 4 sets forth an illustration of an example embodiment of a district energy system interior pipe housing fluid, and a series of exterior pipes filled with phase change materials.

FIG. 5 sets forth an illustration of an example embodiment of a district energy system exterior pipe housing fluid, and a series of interior pipes filled with phase change materials.

FIG. 6 sets forth an illustration of an example embodiment of a district energy system interior pipe housing fluid, and a series of exterior pipes filled with phase change materials.

FIG. 7 sets forth an illustration of an example embodiment of a district energy system interior pipe housing fluid, an exterior pipe surrounding the interior pipe, between which is filled with phase change material.

FIG. 8 sets for a flow diagram of an example embodiment of a district energy system.

### DETAILED DESCRIPTION

Implementations and embodiments described herein can be understood more readily by reference to the following detailed description, example embodiments, and drawings. In the following discussion, a general description of the system and its components and apparatuses is provided, along with a discussion of the methods and operations of the same. It will be known to those of skill in the art that district energy systems exist in multiple configurations and scales, and serve a variety of heating and cooling applications. Additionally, district energy systems may be in separate circuits or in the same, wherein there may be only a heating component or a cooling component, or both. District energy systems are referred to generally including both the heating and cooling components, the additional embodiments herein are applicable to both heating and cooling, the selection of the PCM material for each given process differs but the principles disclosed herein remain the same.

It is important to note, any PCM not inconsistent with the objectives of the present disclosure can be used. As a synopsis, PCM is a substance which can release or absorb sufficient energy at a phase transition to provide useful heating and cooling properties, typically, by either melting and solidifying at a phase change temperature. The phase change transition may also include non-classical states of matter, such as forming a crystalline structure. There are several classes of PCM that are applicable to the present disclosure; including organic, or carbon containing materials, materials derived from petroleum, plants, or animals; and inorganic materials, namely salt hydrates; and eutectic, a mixture of both organic and inorganic components.

The PCM (or combination of PCMs) used in a particular instance can be selected based on a relevant operational temperature range for the specific end use or application. As understood by one having ordinary skill in the art, a phase transition temperature described herein (such as a phase transition temperature of “X” ° C., where X may be 50° C., for example) may be represented as a normal distribution of temperatures centered on X° C. In addition, as understood by one having ordinary skill in the art, a PCM described herein can exhibit thermal hysteresis, such that the PCM exhibits a phase change temperature difference between the “forward” phase change and the “reverse” phase change (e.g., a solidification temperature that is different from the melting temperature). For example, in some cases, the PCM has a phase transition temperature within a range suitable for mediating heating applications or preserving the temperature for cooling systems. In other embodiments the PCM can be seen as a heat sink or energy storage, wherein the phase change helps to mediate temperatures and provide stability within the system. In further embodiments, the PCM has a phase transition temperature within one of the ranges of Table 1 below.

TABLE 1
Partial sampling of phase transition temperature
ranges for PCMs within a district energy system.

```
Sampling of Phase Transition Temperature Ranges
150-175° C.
100-120° C.
  70-100° C.
  50-80° C.
  45-85° C.
  16-23° C.
    5-15° C.
    1-7° C.
    0-5° C.
  −15-0° C.
```

As described further herein, a particular range can be selected based on the desired application. A PCM applied in a district energy system as described herein can absorb and/or release energy using any phase transition not inconsistent with the objectives of the present disclosure. For example, the phase transition of a PCM described herein, in some embodiments, comprises a transition between a solid phase and a liquid phase of the PCM, or between a solid phase and a mesophase of the PCM. A mesophase, in some cases, is a gel phase. Thus, in some instances, a PCM undergoes a solid-to-gel transition. Further, other transitions are known and disclosed herein, such as a solid to solid, solid to crystalline, a solid to liquid, liquid to crystalline, and a liquid to liquid change, to name a few.

Moreover, in some cases, a PCM or mixture of PCMs has a phase transition enthalpy of at least about 50 kJ/kg or at least about 100 kJ/kg. In other embodiments, a PCM or mixture of PCMs has a phase transition enthalpy of at least about 150 kJ/kg, at least about 200 kJ/kg, at least about 300 kJ/kg, or at least about 350 kJ/kg. In some instances, a PCM or mixture of PCMs has a phase transition enthalpy between about 50 kJ/kg and about 350 kJ/kg, between about 100 kJ/kg and about 350 kJ/kg, between about 100 kJ/kg and about 220 kJ/kg, or between about 100 kJ/kg and about 250 kJ/kg. Several distinct advantages of PCM include the thermal control ability, the high latent heat storage capacity, the small volume change in phase transformation, the high specific heat capacity, the chemical stability and lack of degradation over many cycles, the high thermal conductivity, the high density of the material, the noncorrosiveness, the nonflammable aspects, the nontoxicity, and the relatively low cost of the material.

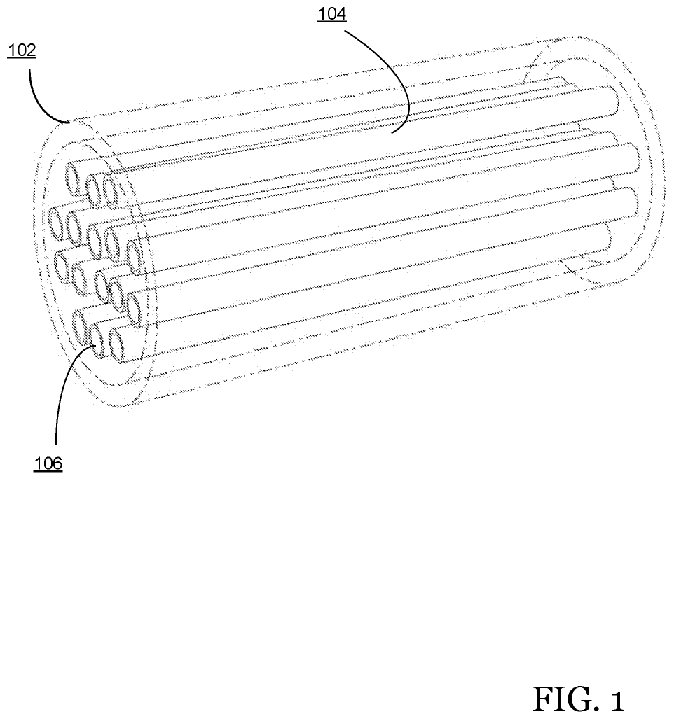

We continue our discussion with the example embodiment in FIG. 1. FIG. 1 sets forth an illustration of an example embodiment of a district energy system exterior pipe and a series of interior pipes filled with phase change materials. The exterior pipe (102) is often comprised of iron, or other metal pipe, but may also include high density polyethylene (HDPE), or polyvinyl chloride (PVC). The diameter of the exterior pipe (102) ranges from several feet to inches, with a typical size of 24 inches for the main lines and branding to smaller diameters at destination sources. Any size exterior pipe is applicable to the present embodiment, if the capability to transport fluid such as water is present. Housed inside the exterior pipe (102) is a plurality of interior pipes (104). In the present example a multiplicity of interior pipes is disclosed, in additional embodiments the interior pipes may number one or more. The interior pipes (104) of the example embodiment are filled with PCM. In the example embodiment they are sealed wherein the PCM does not directly contact the flowing or resting water within the exterior pipe (102). The PCM may be at rest or may be circulated depending upon the design and nature of the installation. By its nature PCM does not require mechanical input, and makes it particularly ideal for applications in the example embodiments herein. The interior pipes (104) are most often comprised of a metal with a high degree of thermal conductivity. Thermal conductivity is defined herein as the

$$K = \frac{Qd}{A Δ T}$$

where K is thermal conductivity, Q is the amount of heat transfer, d is the distance between two isothermal planes, A is the area of the surface, and delta T is the change in difference in temperature. Typical embodiments for interior pipe material include aluminum, copper, brass, steel, and bronze. However, in additional embodiments metal pipes with lower thermal conductivity (iron) may be used if they possess aspects such as cost savings, applicability to the current system, corrosion resistance, or other properties that will be known to those of skill in the art. In further embodiments the interior pipes may comprise high density polyethylene (HDPE), or polyvinyl chloride (PVC), both of which have a low thermal conductivity but nonetheless are cost efficient, durable, and scalable. Additionally, in other embodiments the interior pipes may be a grid formation or a formation of pipes that increase the surface area of the interior pipes to the flowing fluid within the exterior pipe. In the present embodiment the flowing fluid is water, in additional embodiments the fluid may be graywater, brown water, black water, or other fluid utilized in district heating and cooling systems. In certain embodiments waste water is used, in others a clean water source is required, the differing aspects may be combined in any fashion to encompass the goals of the district energy system.

The thermal storage capacity and phase change temperature of the PCM inside the interior pipes (104) varies depending on the heating and cooling side, as well as conditions such as flow rate, diameter of interior pipes, diameter of the exterior pipe, the location along the district energy pathway, and more. Interacting, in the present disclosure, is placing the PCM in thermal communication with the heat source. In one embodiment, the PCM interacts when it is housed within an interior pipe and that interior pipe experiences the flow of district energy water or other fluid, by interacting the PCM transitions phases and absorbs or releases energy. In another aspect, the PCM interacts when the flowing district energy water or fluid is flowing in vicinity to the PCM. The PCM is in thermal communication when it is capable of transferring thermal energy from or to itself, typically through the metal surface, or other surface of the pipes, or the environment, or any in combination. In the present embodiment the transition point for the PCM is within 30° of the fluid within the exterior pipe. In additional embodiments, such as on the cooling side the phase transition may be just several degrees apart to absorb energy at or above the goal of an upper limit of cold fluid. Similarly, when the system catches up and conditions normalize the PCM material may charge, under ideal conditions, and thus maintain the effectiveness of the system by preserving and controlling thermal conditions within the district energy system.

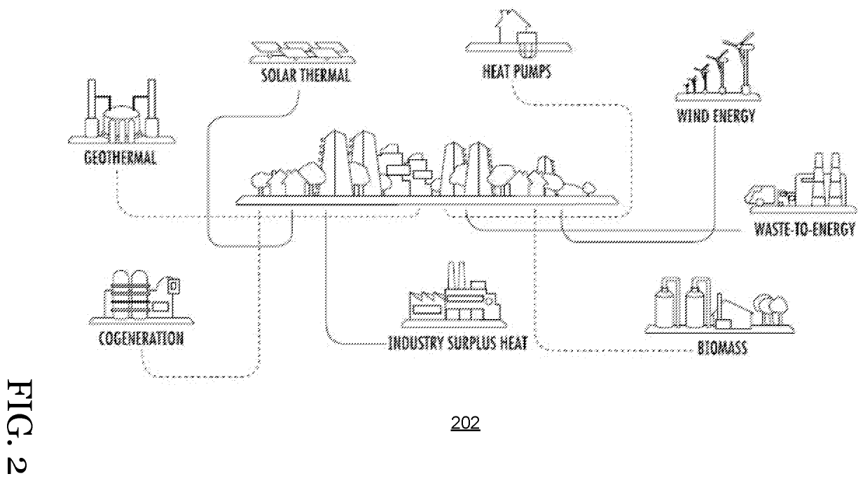

Turning now to the example disclosed in FIG. 2. FIG. 2 sets forth an example illustration of a district energy system (202). The district energy system (202) is focused on the heating side, and outlines the various sources of district energy thermal heat generation as well as the network of pipes and connectors. The core element of many district energy heating systems is a heat-only boiler station. Cogeneration facilities are often added in parallel to the boiler station. Geothermal sources may also serve as resources for a district energy system, and the use of such sources is well known by those of skill in the art.

In one embodiment PCM material is placed alongside the spans of interconnected pipe. In other aspects, the PCM material may be placed in clusters or in the aggregate along the network, the PCM filled pipes may be placed closer to the destination to effectively handle heat loss near destination facilities. Still, in other aspects, PCM filled pipes or connector assemblies may be located near heat source generation and may effectively retain thermal capacity or work to set thermal energy goals.

A cogeneration facility or combined heat and power utilizes a heat engine or power station to generate electricity and useful heat at the same time. Trigeneration or combined cooling, heat, and power refers to the simultaneous generation of electricity and useful heating and cooling from the combustion of a fuel or a solar heat collector. The terms cogeneration and trigeneration can also be applied to the power systems simultaneously generating electricity, heat, and industrial chemicals. The supply of high-temperature heat first drives a gas or steam turbine-powered generator. The resulting low-temperature waste heat is then used for water or space heating. In the example embodiment the waste heat is utilized in warming the fluid for distribution along the district energy pathway. PCM filled inner or exterior pipes, then help regulate the warmed water or fluid, and maintain the specified temperatures along the pathway. A cogeneration facility at smaller scales (typically below 1 MW), uses a gas engine or diesel engine may be used.

Trigeneration differs from cogeneration in that the waste heat is used for both heating and cooling, typically in an absorption refrigerator. Thus in one embodiment the absorption refrigerator may be utilized as a cooling source and part of a cooling network in a district energy system (202). Combined cooling, heat, and power systems can attain higher overall efficiencies than cogeneration or traditional power plants. Heating and cooling output may operate concurrently or alternately depending on need and system construction. Therefore, in the example embodiment of FIG. 2, the cogeneration facility may serve the district energy heating and cooling source needs and is one example of source input into a district energy system (202).

Biomass generation heating systems generate heat from biomass fuels. Biomass fuels typically include wood fuel, and or agricultural pellets, agricultural waste, and other derivatives of biomass. Systems include direct combustion, gasification, combined heat and power, anaerobic digestion, and aerobic digestion. Biomass fuels generating electricity may be utilized to generate a cooling source for a cooling network. The PCM filled pipes may route alongside the cooling network, wherein periods of high demand and rising temperatures in the cooling network, activate to withdraw heat from the system and maintain thermal goals of the cooling network. Similarly, Biomass may directly supply heat to a source or as waste heat, or as electrically generated heat.

Waste to energy and industry specific heat are additional aspects of a heating network within a district energy system. The PCM filled pipes are adjusted with the appropriate materials for the design and layout of the heat network. For example, in one embodiment PCM filled pipes near the source may have a transition phase distinctly higher from PCM filled pipes near the destination. Similarly, there may be a complex network of PCM filled pipes both internally and externally to a fluid source flowing pipe that assists in regulating the thermal environment of the fluid.

Geothermal, solar thermal, heat pumps, and wind energy are all distinct energy sources that can generate heat and often times electricity, thus have the capability to provide resources for a heat source as well as a cooling source within a district energy system. Heating sources, in the example embodiment of FIG. 2, provide a plethora of options along the network, wherein PCM supports and alleviates the need for additional resources by aiding in maintaining temperatures. In additional embodiments heat generating sources beyond the original source destination may not be required with the aid of PCM piping and thermal stabilization.

More modern district heating and cooling networks utilize transport of fluid and or water at near ground ambient temperatures, and make use of a heat pump in a power plant on site to a local circuit or heating network. In this example embodiment the PCM filled pipes may be utilized in the local circuit and may prove especially beneficial in local circuits that distribute in cooler climates. Similarly, in additional embodiments the PCM filled pipes may be utilized externally as insulation near the local destination pipes, or insulation for the local runs that require stabilization of temperature or other features as discussed herein.

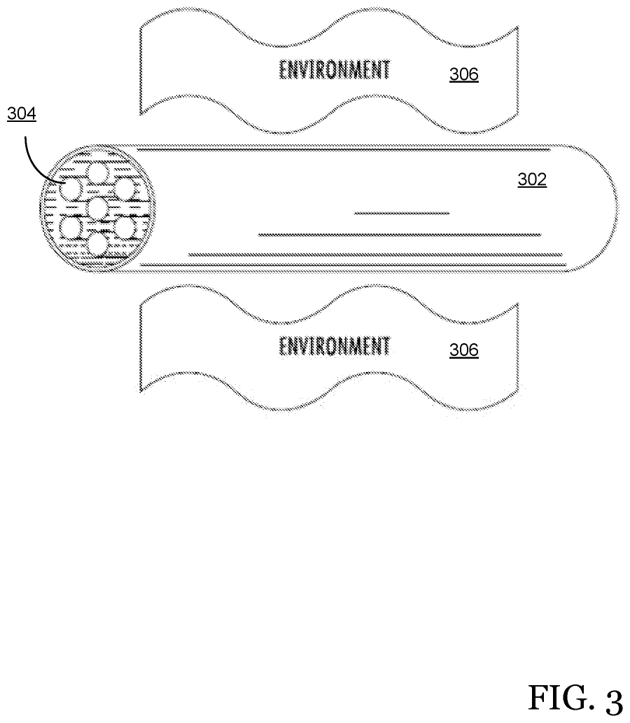

FIG. 3 sets forth an illustration of an example embodiment of a district energy system exterior pipe and a series of interior pipes filled with phase change materials. The exterior pipe (302) traverses along the pathway of the district energy network. The exterior pipe (302) is often shrouded in insulation for temperature and condensation control. In the present example the exterior pipe (302) is shrouded in mineral wool, that includes rock and slag wools, which are inorganic strands of mineral fiber bonded together using organic binders. Mineral wools are capable of operating at high temperatures and exhibit high resiliency to heat applications. The benefits of insulation are numerous, including protection from excess condensation, extreme temperatures, and control of noise, to name a few. Additional embodiments include glass wools, which are high temperature fibrous insulation materials, where inorganic stands of glass fiber are bound together using a bind. Glass wools are noted for their thermal properties of insulation as well as acoustic dampening performance. In further embodiments, rigid foam made of phenolic, PIR, or PUR foam insulation is used, performance of the various foams includes lowering thermal conductivity and providing a strong condensation barrier. Polyethylene is both used in piping itself, but also to shroud metallic pipes to provide insulation and protection. Silica aerogel is another insulator that may be used as an insulation barrier, current adaptation includes aerogel blankets for regions experiencing significant thermal loss.

In the example embodiment of FIG. 3, the interior pipes are in an assembly pattern that may be manufactured, prefabricated, or designed on site for application to a district energy system. Note that in the example embodiments flow impedance is likely to occur, but not a significant loss, due to the fluid dynamics of the interior pipes. The interior pipes (304) may be radially clustered at the core, or moved to the exterior, or placed in random configuration, the principle method is to have contact with the flowing fluid to allow for the PCM interior pipes to absorb, release, or other transition phases upon reaching thermal limits. Additionally, specific patterns of interior pipes may result in benefits of flow dynamics, including flow rate, as well as aspects of surface area of the interior pipes to the flowing fluid. The surface area factor contributes to many embodiments, including whether to increase the numerosity of interior pipes and or to adjust parameters such as flow pressure of the district energy fluid. The environment (306) in the example embodiment is earth materials, however, it is noted that the networked systems of district energy flow through a variety of surfaces, buildings, and other environments. In additional aspects the exterior pipe, housing interior pipes filled with PCM, may network through various levels of soil substrate, through heat and cold sources, and along a network of buildings, city streets, connection points, and substations, and into further arterial flows of local networks until finally resulting in delivery at a destination source. The ability for PCM to flow into different configuration and to show little change over transition in volume further enhances the ability of PCM filled interior and or exterior pipes to traverse these complex networks and pathways. In one embodiment the PCM filled pipes run internally and externally to a main water or fluid pipe. In doing so the exterior PCM filled pipes handle climatic environment such as interior spaces of buildings, while the interior pipes assist in regulating temperatures within the source fluid. These are but a few examples of embodiments, it should be known that the diverse, sprawling, and often complex network of interacting pipes and connectors within a district energy system are contemplated and disclosed as possessing attributes in which PCM filled piping can be configured and or incorporated to aid in the goals of thermal regulation in district heating and cooling.

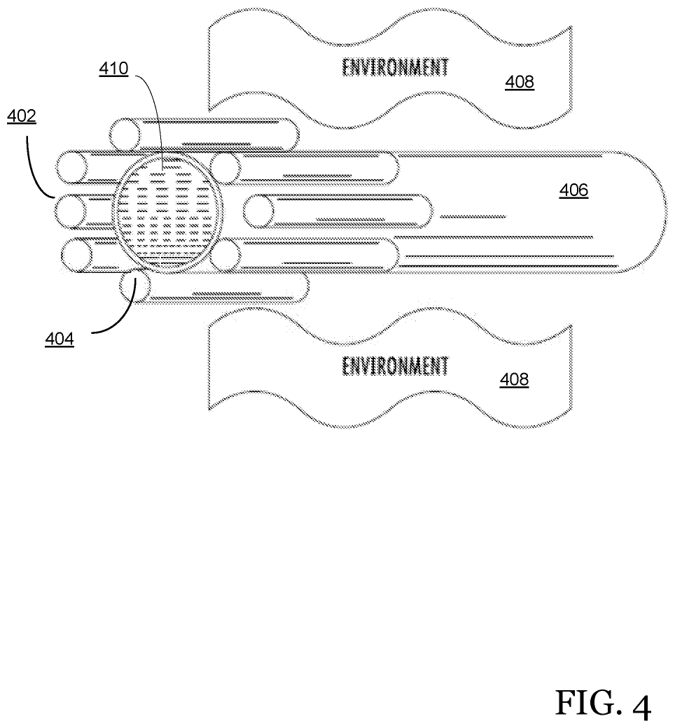

Turning now to FIG. 4. FIG. 4 sets forth an illustration of an example embodiment of a district energy system interior pipe housing fluid (410), and a series of exterior pipes filled with phase change materials. In the example embodiment the exterior pipes (402) are filled with PCM (404) and perform the role of insulation and thermal regulation of the external environment and within the interior pipe (406). They are often used in connection with insulation to prevent condensation but also mediate temperatures within extreme environments. In such systems a combination or interior and exterior pipes filled with PCM (406) may be added to a main water pipe or fluid line (410) in a district energy system to provide enhanced benefits or increased results in particular scenarios. The functionality of the PCM filled pipes allows it to adapt and conform to variable network pathways and configurations and is deployable across a variety of environments. Included in this disclosure is the use of a flexible hose to house the interior PCM that is completely sealed and allows a serpentine movement throughout the district energy system. Metallic hoses also offer the added benefit of a high degree of thermal conductivity. Since the PCM is not under pressure within the interior pipes, several metallic hoses are available to meet the needs of the present embodiment. Note also that several metallic hoses may be interconnected and or formed into patterns to accomplish heating or cooling objectives at or near the destination or along the pathway of networked infrastructure.

Further, in the example of FIG. 4 the exterior pipes may be in direct contact with the interior pipe (406) to allow transfer of heat from the materials, this is especially relevant to transfer between two metallic surfaces. In such a system the exterior pipes (402) filled with PCM (404) act as a heat sink. In other aspects separation may be utilized and the exterior pipes (402) may help to regulate environmental conditions. The PCM in the present embodiment is suited for a heat network, in other aspects the PCM may be tailored to cooling networks. In even further embodiments the PCM is for blended systems or mixed use systems. Note, also, that the exterior PCM disclosures, such as FIG. 4 may be housed within building complex walls and provide insulation and retention for a variety of environments. Similarly, the pipe complex (interior and exterior pipes) is adaptable to traversing a variety of angles, degrees, and directions, and is adaptable to a variety of climates and conditions. The environment (408) is any environment previously disclosed, but also not limited to underground, through lakes or aquifers, in and around streets and buildings, and even transgressing rivers or other elements.

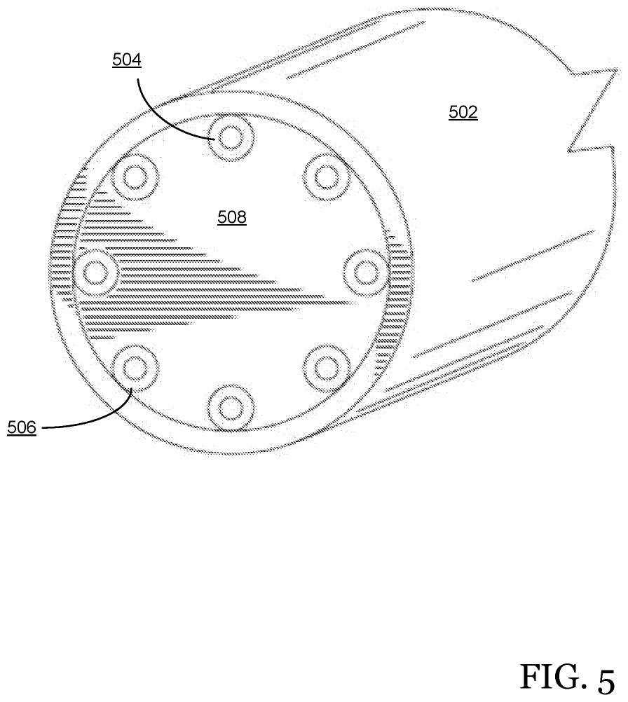

FIG. 5 sets forth an illustration of an example embodiment of a district energy system exterior pipe housing fluid, and a series of interior pipes filled with phase change materials. In the present embodiment the exterior pipe (502) houses a series of radially located interior pipes (504). In this embodiment the gaskets (506) show insertion points on a section of district energy piping that provides for the insertion or removal of PCM filled interior pipes. Typical gaskets include rubber or synthetic rubber gaskets that provide a water tight or fluid tight, under pressure, seal. Not pictured, and often utilized in combination may be a butterfly valve or other valve to release pressure or stop the flow while exchanging out PCM interior pipes. As district energy systems grow and evolve the need to exchange PCM materials is met by this system. Gasket properties include non-toxic, approved for use in contact with hot and cold drinking water (NSF, WRc, DVGW, ACS FDA, etc.), for high and low temperatures, anti-abrasive, liquid silicon runner, high mechanical and chemical resistance, rip proof, approved to EN 681, extremely elastic, for special or aggressive liquids, weatherproof, anti-glycol, and anti-chlorine, to name a few properties.

District energy systems may be equipped with sensing intelligence throughout the system to continuously monitor and report thermal energy and the status of source and destination facilities. The sensing intelligence often comprises a host of general and special purpose computing devices, including microcontrollers that are equipped to sensors and probes, pneumatics, actuators, and the like to actively take readings of the ambient environment/water and other materials and objects within system. Typical general purpose computer, special purpose computers, and microcontrollers include systems equipped with RAM, short term storage (volatile memory), long term storage (non-volatile memory), a central processing unit, graphical processing units, a I/O module or adapter, as well as a wireless, cellular, and or Bluetooth™ chipsets for communications. More advanced techniques include large scale dedicated computing systems equipped to cloud storage infrastructure to monitor and exchange intelligence on the various materials and components along the district energy system. By imparting computational intelligence, the district energy systems can regulate the thermal capacity of PCM by adding or subtracting additional PCM filled pipes and connectors through operations utilizing servomotors or linear actuators, or hand placement, that distribute and or introduce additional PCM filled pipes to the system. Furthermore, the analysis on the system aids in placement and metrics of PCM usage. The computational intelligence further aids in relaying operating conditions and information to a central storage server, computer, or user, often times operating as a control system.

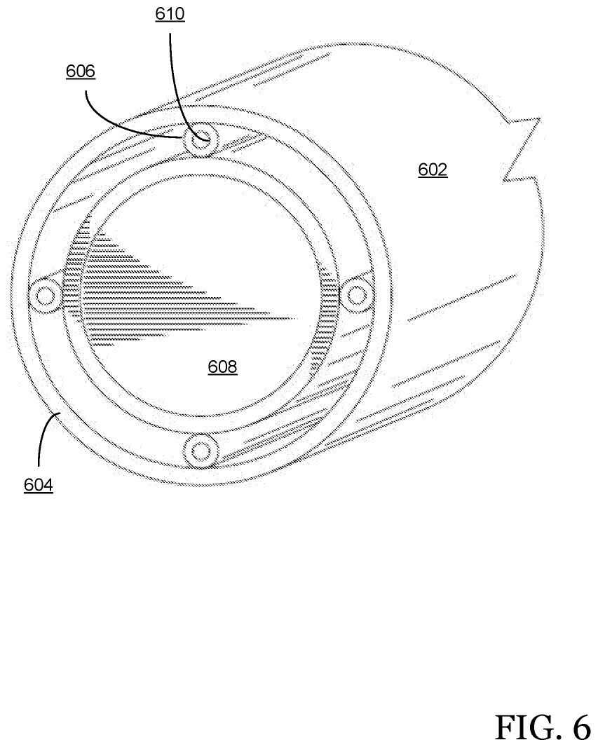

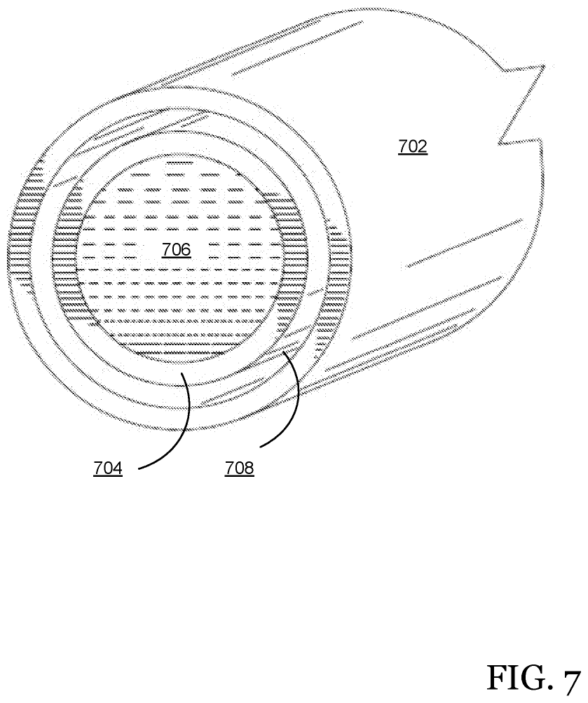

FIG. 6 sets forth an illustration of an example embodiment of a district energy system interior pipe housing fluid, and a series of exterior pipes filled with phase change materials. In FIG. 6, the exterior pipe (604) is shrouded in insulation, wherein it can be any of the insulations previously discussed, including wool insulation which provides a moisture and condensation barrier, along with acoustic dampening. Further, wool insulation is noted for performance on ground environments. The exterior pipe (604) houses the interior pipe (602), in which the district energy heating or cooling fluid is flowing through. The fluid (608) can be water, but may also be graywater on a return transit, or graywater in a circuit for non-human contact usage. Additional fluids are utilized in a renewable setting and allow for a variety of industrial processes to account for energy requirements within a district energy system. The medial pipes (606) house the PCM (610) and sit between the interior pipe (606) and exterior pipe (604). In further embodiments, in particular in FIG. 7, the PCM is flowing freely between the interior and exterior pipes. In the present embodiment the PCM (610) is housed in medial pipes (606) that allow for advancements such as customization of a variety of PCM and blending various phase change transition points to accomplish the goals of the district energy system.

FIG. 6 discloses further advancements in a pipe within a pipe design, allowing for medial pipes (606) to interchange and provide an insulating and thermos-controlled barrier to the external pipe (604) and the environment surrounding it. The disclosure in FIG. 6 can be combined with any of the interior pipe disclosures to provide an additional level of thermoregulation and control. For example, interior pipes similar to those depicted as medial pipes may lie inside the main water main (in this case the interior pipe) and provide the benefits and properties of PCM as the fluid or water flows over the pipes.

In FIG. 7, an illustration of an example embodiment of a district energy system interior pipe housing fluid, an exterior pipe surrounding the interior pipe, between which is filled with phase change material. Similar to the example embodiment of FIG. 6, a pipe in pipe design is utilized for added safety, control, stability, and adaptability. The exterior pipe (702), shrouded in insulation, houses an interior pipe (704) that transports the district energy heating or cooling fluid. The PCM is housed between the interior (704) and exterior pipe (702) and flows freely between the two pipes. In other aspects the PCM may be contained in segmented chambers, and in even further embodiments the PCM may be isolated along a matrix or within a metallic matrix or grid.

Further, in FIG. 7, the interior and exterior pipes may be made of iron, or other metal, or of a compound, or polyvinyl, and may be changed or altered. In other aspect a metallic hose may comprise the interior pipe and allow for flexibility in points near destination addresses or in areas in which the need for a bendable metallic implementation is required. Further, any PCM not inconsistent with the present disclosure may be applied between the interior and exterior pipe, and that the usage of PCMs vary depending upon the goal set to be achieved for the various heating or cooling needs within a district energy system.

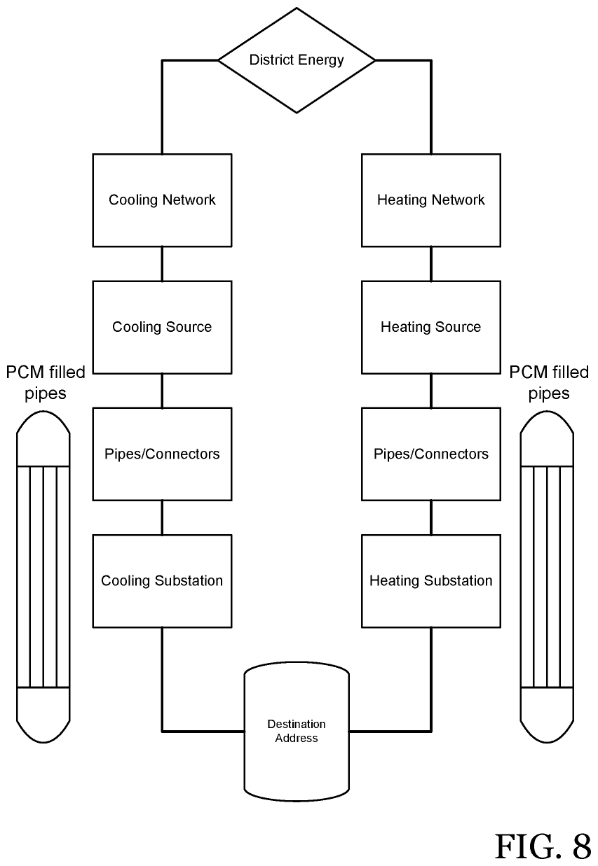

Turning now to FIG. 8, a flow chart of an example district energy system. Both the heating and cooling networks are disclosed. The district energy system begins with a cooling or heating source, wherein the source fluid or water is heated or cooled by the various sources, examples of which are further depicted in FIG. 2. The thermally altered fluid is then sent through a series of pipes and connectors, wherein the application of PCM as disclosed in the previous embodiments is applied to help regulate, control, and provide temperature goals for the district energy system. The PCM filled pipes and PCM filled apparatuses are applicable from the source point to the destination address. A typical district energy system may apply a variety of differing PCMs in a variety of differing enclosures throughout the network without departing from the present disclosure. The pipes and connectors and the PCM filled pipes interact through the flowing water and the surface area of the pipes and connectors. The interaction is one driven by the force or pressure in the district energy network, various aspects of hydrodynamics are at play, including capillary forces, and Bernoulli's principle, to name a few. The design and aspects of the interior housed PCM filled pipes are in direct relation to the design of the system, including accounting for volumetric changes due to the interior pipes, as well as flow rates, turbidity, and other principles as will be known to those of skill in the art. The advantages of PCM providing non mechanical temperature regulation and control are numerous, and the applicability to district energy systems provides additional levels of conservation, energy efficiency, and design freedom.

Various implementations of systems, apparatuses, and methods have been described in fulfillment of the various objectives of the present disclosure. It should be recognized that these implementations are merely illustrative of the principles of the present disclosure. Numerous modifications and adaptations thereof will be readily apparent to those skilled in the art without departing from the spirit and scope of the present disclosure. For example, individual steps of methods described herein can be carried out in any manner and/or in any order not inconsistent with the objectives of the present disclosure, and various configurations or adaptations of apparatus described herein may be used.

1. A system for district energy thermal control, the system comprising:
an exterior pipe, wherein the exterior pipe is configured to transport fluid;
one or more interior pipes disposed within the exterior pipe; and
one or more phase change materials disposed within the one or more interior pipes.

2. The system of claim 1, wherein a phase transition temperature of the one or more phase change materials is within 30° C. of the fluid flowing through the exterior pipe and around the one or more interior pipes.

3. The system of claim 1, wherein the fluid is water.

4. The system of claim 1, wherein the fluid is greywater.

5. The system of claim 1, wherein the phase change materials are fully enclosed or sealed within the one or more interior pipes.

6. The system of claim 1, wherein the one or more interior pipes comprises a flexible metallic hose.

7. The system of claim 1, wherein the one or more interior pipes comprises a metal.

8. The system of claim 1, further comprising gaskets on the exterior pipe;
wherein the gaskets are configured to allow exchange of the one or more interior pipes.

9. The system of claim 1, wherein the exterior pipe is encased in insulating material.

10. The system of claim 1, wherein the one or more interior pipes houses a sub complex of one or more additional interior pipes.

11. A system for district energy thermal control, the system comprising:
an exterior pipe;
an interior pipe disposed within the exterior pipe;
fluid disposed within the interior pipe; and
phase change materials disposed between the exterior pipe and the interior pipe.

12. The system of claim 11, wherein the fluid disposed within the interior pipe is water.

13. The system of claim 11, wherein a phase transition temperature of the phase change materials is within 30° C. of the fluid within the interior pipe.

14. A method for district energy thermal control, the method comprising:
distributing phase change materials in one or more interior pipes disposed within an exterior pipe;
interacting the one or more interior pipes to environmental temperatures within the exterior pipe; and
transitioning the phase change materials, wherein transitioning the phase change materials transition states in relation to the environmental temperatures within the exterior pipe.

15. The method of claim 14, further comprising transferring thermal energy from the environmental temperatures within the exterior pipe to the one or more interior pipes housing the phase change materials.

16. The method of claim 14, further comprising transferring thermal energy to the environmental temperatures within the exterior pipe from the one or more interior pipes housing the phase change materials.

17. The methods of claims 14, further comprising flowing water through the exterior pipe.

18. The method of claim 14, further comprising interacting the phase change materials to a heat source.

19. The method of claim 14, further comprising interacting the phase change materials to a cooling source.

20. The method of claim 14, further comprising integrating the one or more interior pipes into a heat exchanger.

21. The method of claim 14, further comprising integrating the one or more interior pipes into a district energy exchange substation.
